(19) United States
(12) Patent Application Publication
(10) Pub. No.: US 2006/0273663 A1
(43) Pub. Date: Dec. 7, 2006

(54) Power outlet with automatic shutoff

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/143,215

(22) Filed: Jun. 2, 2005

(51) Int. Cl. H01H 35/00

(52) U.S. Cl. 307/126

(57) ABSTRACT

An automatic switched power circuit with automatic shutoff under standby power conditions comprises a power outlet including first and second terminals for connection to a power source and first and second sockets for receiving a plug of a powered device. The first terminal is electrically connected to the first socket. A switch is electrically connected between the second terminal and the second socket. A sensor senses power drawn through the power outlet. A control circuit is coupled to the sensor and the switch. The control circuit determines if power drawn through the power outlet comprises standby power and in response thereto operates the switch to disconnect the second terminal and the second socket.

### FIELD OF THE INVENTION

The present invention relates to a power circuit and more particularly, a power circuit with automatic shutoff under standby conditions.

### BACKGROUND OF THE INVENTION

A home or business typically uses numerous electrically powered devices such as lamps, appliances, and electronic devices or the like. Typically, the device includes a power cord terminating in a plug which is inserted into a wall outlet to power the device. Perhaps the simplest example is a lamp. When the lamp is plugged into the outlet, the lamp can be turned on or turned off. When turned on, the lamp draws an amount of power determined by the bulb size, such as, for example, 100 watts. When the lamp is turned off, the bulb is disconnected from the power source and the lamp draws zero power. Thus, the lamp can be considered as energy efficient when turned off.

More recently, devices, particularly electronic devices, may operate in a mode which consumes what is referred to as “standby power”. Most commonly, standby power is consumed when the device is plugged into an outlet but is in an off condition. One example is a television set. Many television sets use an “instant on” feature that provides for a television set to turn on more quickly. This is accomplished by providing some power to the television even when it is turned off. Similarly, a remote control operated television consumes power in order to communicate with the remote control device.

The amount of power consumed by the device depends on its particular needs. Published tables are available that show amount of standby power for various devices. By way of example, a standby power summary table published at http://standby.lbl.gov/data/summaytable.html lists minimum, average and maximum standby power wattage values for various devices. For example, for a DVD player the values are 1.3, 4.2 and 12.0. For a printer, the values are 4, 5 and 6. For a video game, the values are 0.9, 1.3 and 2.0. For a VCR the values are 1.5, 6.0 and 12.8.

For energy efficiency, it is obviously desirable to minimize consumption of standby power. This can be accomplished by designing devices with this desire in mind. However, a manufacturer may not consider this an important factor in the product design. While a user can selectively choose the types of devices to purchase, standby power consumption, even if known, may not be a consideration in a purchase decision. Nevertheless, a user can minimize standby power consumption by unplugging a device when not in use. However, if the user forgets to unplug the device, then the standby power consumption remains.

The present invention is directed to solving one or more of the problems discussed above in a novel and simple manner.

### SUMMARY OF THE INVENTION

In accordance with the invention, there is provided an automatic switched power circuit with automatic shutoff under standby power conditions.

Broadly, in accordance with one aspect of the invention, there is disclosed an automatic switched power circuit with automatic shutoff under standby power conditions comprising a power receptacle including first and second nodes for selectively supplying power from a power source to a powered device. Sensing means sense power drawn by the power receptacle. Switch means are electrically connected between the first and second nodes for selectively electrically connecting the first and second nodes. Control means are coupled to the sensing means and the switch means. The control means determine if power drawn by the power receptacle comprises standby power and in response thereto operating the switch means to disconnect the first and second nodes.

It is a feature of the invention that the control means comprises user select means for selecting a standby power level and the control means compares sensed power to the standby power level to determine if power drawn by the power receptacle comprises standby power.

In one aspect of the invention, the power receptacle comprises a plug. In another aspect of the invention, the power receptacle comprises an outlet.

It is another feature of the invention that the control means comprises a means for manually resetting the control means to operate the switch means to electrically connect the first and second nodes.

It is a further feature of the invention that the control means comprises a programmable control device operating in accordance with a stored program.

It is yet another feature of the invention that the switch means comprises a control relay.

There is disclosed in accordance with another aspect of the invention, an automatic switched power circuit with automatic shutoff under standby power conditions comprising a power outlet including first and second terminals for connection to a power source and first and second sockets for receiving a plug of a powered device. The first terminal is electrically connected to the first socket. A switch is electrically connected between the second terminal and the second socket. A sensor senses power drawn through the power outlet. A control circuit is coupled to the sensor and the switch. The control circuit determines if power drawn through the power outlet comprises standby power and in response thereto operates the switch to disconnect the second terminal and the second socket.

It is a feature of the invention that the control circuit comprises a user select device for selecting a standby power level and the control circuit compares sensed power to the standby power level to determine if power drawn by the power outlet comprises standby power.

It is another feature of the invention that the control circuit comprises a manual reset device to selectively operate the switch to electrically connect the second terminal to the socket.

It is still another feature of the invention that the control circuit comprises a programmable control device operating in accordance with a stored program.

It is a further feature of the invention that the switch comprises a control relay.

It is yet another feature of the invention that the control circuit determines if power drawn through the power outlet comprises standby power by determining if some power is drawn through the power outlet and the amount of power drawn is less than a selectable standby power limit.

In accordance with another aspect of the invention, the automatic switched power circuit further includes a second power outlet including third and fourth sockets for receiving a plug of a powered device. The first terminal is electively connected to the third socket. A second switch is electrically connected between the second terminal and the fourth socket. A second sensor senses power drawn through the second power outlet. The control circuit is coupled to the second sensor and the second switch and determines if power drawn through the second power outlet comprises standby power and in response thereto operates the second switch to disconnect the second terminal and the fourth socket.

There is disclosed in accordance with a further aspect of the invention an automatic switched power circuit with automatic shutoff under standby power conditions comprising a power plug including first and second power terminals for connection to a power source and first and second conductors connected to a powered device. The first terminal is electrically connected to the first conductor. A switch is electrically connected between the second terminal and the second conductor. A sensor senses power drawn through the power plug. A control circuit is coupled to the sensor and the switch. The control circuit determines if power drawn through the power plug comprises standby power and in response thereto operating the switch to disconnect the second terminal and the second conductor.

It is a feature of the invention that the control circuit comprises a user select device for selecting a standby power level and the control circuit compares sensed power to the standby power level to determine if power drawn by the power plug comprises standby power.

It is another feature of the invention that the control circuit comprises a manual reset device to selectively operate the switch to electrically connect the second terminal to the second conductor.

It is another feature of the invention that the control circuit comprises a programmable control device operating in accordance with a stored program.

It is another feature of the invention that the switch comprises a control relay.

It is still a further feature of the invention that the control circuit determines if power drawn through the power plug comprises standby power by determining if some power is drawn through the power outlet and the amount of power drawn is less than a selectable standby power limit.

Further features and advantages of the invention will be readily apparent from the specification and from the drawings.

### BRIEF DESCRIPTION OF THE DRAWINGS

FIG. 1 is a front elevation view of a power outlet with automatic shutoff in accordance with the invention;

FIG. 2 is a generalized block diagram of the power outlet of FIG. 1 illustrating connection between an AC supply and a powered device;

FIG. 3 is a flow diagram illustrating operation of a program implemented in a control block of FIG. 2; and

FIG. 4 is a generalized block diagram for a power plug with automatic shutoff in accordance with the invention.

### DETAILED DESCRIPTION OF THE INVENTION

In accordance with the invention, an automatic switched power circuit includes automatic shutoff under standby power conditions. The power circuit includes a power receptacle, which could be an outlet or plug, including first and second nodes for selectively supplying power from a power source to a powered device. A sensing means senses power drawn by the power receptacle. A switch means is electrically connected between the nodes for selectively electrically connecting the nodes. A control means is coupled to the sensing means and switch means for determining if power drawn by the power receptacle comprises standby power and in response thereto operating the switch means to disconnect the nodes.

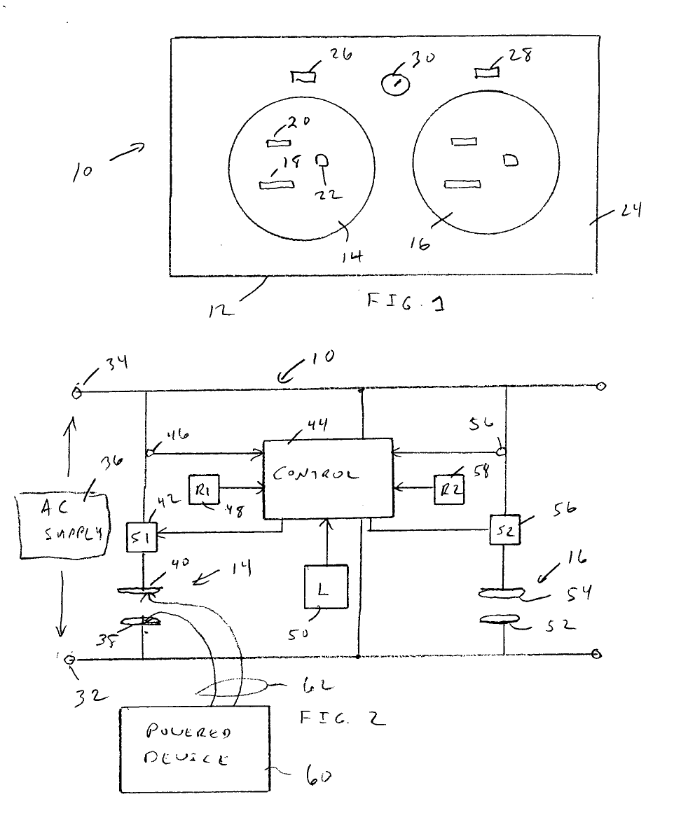

Referring initially to FIG. 1, an automatic switch powered circuit 10 in accordance with a first embodiment of the invention comprises a power receptacle 12. In the illustrated embodiment of the invention, the power receptacle 12 includes a first grounded outlet 14 and a second grounded outlet 16.

For United States power devices, a power supply cord on most modern equipment has a three pin plug. The plug has two flat blade power pins for live and neutral wires and a third round pin for ground. As such, the first outlet 14 includes two parallel blade slots 18 and 20. The first blade slot 18 is larger and is for connection to a neutral supply. The second blade slot 20 is smaller and is for the hot supply line. A ground aperture 22 is for receiving a ground pin. The second outlet 16 is generally similar to the first outlet 14.

The outlets 14 and 16 are surrounded by wall plate 24. The wall plate 24 also includes a first reset button 26 associated with the first outlet 14 and a second reset button 28 associated with the second outlet 16. A rotatable knob 30 is used for selecting a standby power level, as described more particularly below.

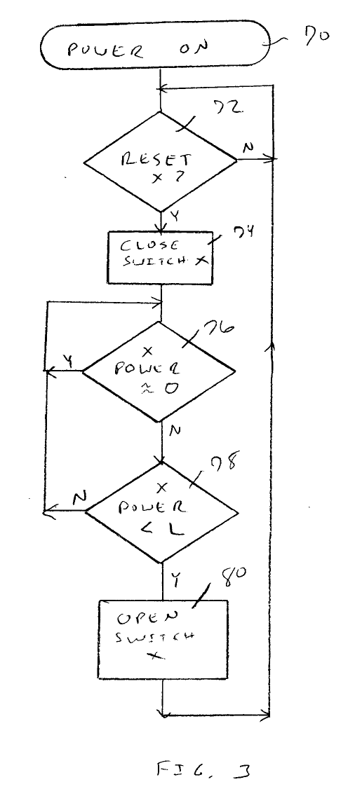

Referring to FIG. 2, the automatic switched power circuit 10 is illustrated in the form of a combined schematic/block diagram. A first power terminal 32 and a second power terminal 34 are provided for connection to an AC supply 36. The AC supply 36 may comprise a conventional 120 volt AC supply such as found in both residential and commercial establishments. For purposes of discussion herein the ground circuit is not shown. The first outlet 14 includes a first socket 38 and a second socket 40. The first socket 38 is aligned with the first slot 18, see FIG. 1, while the second socket 40 is aligned with the second slot 20, see FIG. 1. When a plug is inserted into the first outlet, the pins of the plug are received in the sockets 38 and 40 to provide an electrical connection, as is conventional and well known.

The first terminal 32 is electrically connected to the first socket 38. A first switch 42 is electrically connected between the second terminal 34 and the second socket 40. The first switch 42 is provided for selectively electrically connecting the second terminal 34 and the second socket 40. As such, the first switch 42 may be thought of as providing electrical connection between a first node in the form of the second terminal 34 and a second node in the form of the second socket 40.

A control circuit 44 is connected between the terminals 32 and 34 and as such is powered by the AC supply 36. The control circuit 34, in an illustrated embodiment of the invention, may comprise a conventional microcontroller including processing capability and memory, as is well known, operating in accordance with a stored program. The control circuit 44 is connected to a sensor 46 for sensing power drawn through the first outlet 14. The sensor 46 may directly sense power, i.e., watts, or may sense current which represents power drawn. In fact, the control circuit 44 can determine power using sensed current along with voltage between the terminals 32 and 34, as is well known. The control circuit 44 is also connected to a first reset switch 48 associated with the first reset button 26 and to a variable adjustment device 50, such as a trim potentiometer, associated with the knob 30. Similarly associated with the second outlet 16 are a third socket 52 connected to the first terminal 32 and a fourth socket 54 connected by a second switch 56 to the second terminal 34. The second switch 56 is similar to the first switch 42 and is connected to and operated by the control circuit 44. A second power sensor 56 is connected to the control circuit 44 and senses power drawn by the second power outlet 16. A second reset switch 58 is associated with the second reset button 28, see FIG. 1.

In use, the power circuit 10 in FIG. 2 is utilized by connecting the terminals 32 and 34 to the AC supply 36. As such, assuming the switches 42 and 56 are closed, power is supplied to the first outlet 14 and the second outlet 16. A powered device 60 including a power cord 62 can be plugged into the first outlet 14, as generally illustrated, to supply power from the power source 36 to the power device 60. In accordance with the invention, the control circuit 44 determines if power drawn by the powered device 60 through the first outlet 14 comprises standby power and in response thereto operates the first switch 42 to disconnect the first outlet 14 from the power source 36 as by opening the first switch 42 to electrically disconnect the second terminal 34 from the second socket 40. Similarly, the control circuit 44 also determines if power drawn through the second outlet 16 comprises standby power and in response thereto operates the second switch 56 to disconnect the second outlet 16 from the power source 36 as by opening the second switch 56 to electrically disconnect the second terminal 34 from the fourth socket 54.

Any device designed to operate under standby power will generally operate at a specific power wattage or over some range. A table can be provided to a customer identifying standby power consumption for typical devices. In some instances, standby power might be at a minimum and thus might be zero. Advantageously, the power circuit 10 would not shut off power if zero power is being drawn. As such, the control circuit 44 is generally adapted to determine if some power is being drawn by the powered device 60 and then determining if the amount of power being drawn is a value that represents standby power and, if so, automatically shuts off power to the powered device 60 under standby power conditions. This is done by selectively adjusting the knob 30 to adjust the level value from the adjustment device 50. For example, the knob 30 can include a gradation scale representing standby power to be selected. For example, with the DVD player application, discussed above, minimum standby power is 1.3 watts, average standby power is 4.2 watts and maximum standby power is 12 watts. The control circuit 44 is adapted to compare the preset value set by the adjustment device 50 to any one of a minimum value over a select time period, an average value over a select time period, or a maximum value over a certain time period. If, for example, the control circuit 44 is using average power, then the user would select a value on the order of 4.2 watts with the knob 30. If the control circuit 44 determines that power is being consumed by the powered device 62, i.e., is non-zero, but the amount of power is less than the selected value of 4.2 watts, then the powered device 60 is in a standby power operation and the control circuit 44 is adapted to open the first switch 42 to disconnect power to the first outlet 14.

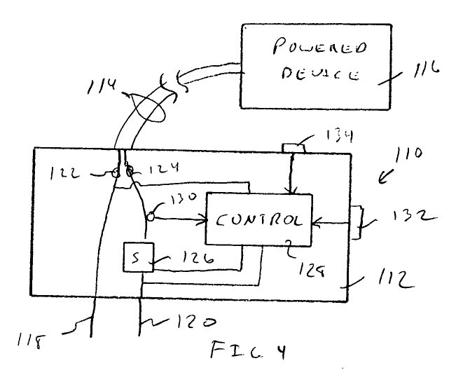

Particularly, FIG. 3 illustrates a flow diagram implemented in the control circuit 44. Control begins when power is turned on to the power circuit 10 at a node 70. The illustrated flow diagram is implemented independently for the first outlet 14 and the second outlet 16. The variable X is used to represent the particular outlet for which the flow diagram is currently operating. For discussion purposes herein, the flow diagram will be described with respect to operation of the first outlet 14, it being understood that operation for the second outlet 16 is similar.

The flow diagram assumes that the power circuit 10 initializes with both switches 42 and 56 open, although both could be closed at power up, if necessary or desired.

A decision block 72 determines if the first reset button 26 has been depressed. If not, then control loops back on the decision block 72 until the first reset button 26 is depressed. Once the reset button 26 is depressed, as determined by the first reset switch 48 being closed, then the first switch 42 is closed at a block 74 to supply power from the second terminal 34 to the second socket 40 to effectively turn on the first outlet 14. A decision block 76 then determines if power sensed by the first sensor 46 is equal to or approximately equal to zero. The power would zero if there was no device plugged into the first outlet 14, or if any device was turned off and not consuming any standby power or if amount of standby power is negligible so that it will be assumed to be zero. For example, this block can be implemented by determining if sensed power is less than a nominal value such as 0.1 watts, or the like, to avoid automatic shutoff when little or no power is being consumed. If power is approximately zero, then the control loops back on the block 76. If power is not approximately zero, then a decision block 78 determines if sensed power drawn through the first power outlet 14 is less than a preset value L set by the knob 30. If not, then power consumption is greater than the selected standby power level and the control circuit 44 assumes that the powered device 60 is under normal operation and control returns to the decision block 76. As such, when a device is turned on, the control will repeatedly loop through the blocks 76 and 78 for normal operation. If the decision block 78 determines that sensed power is less than the preset value L, then it is determined that the powered device 60 is operating under standby power conditions and the first switch 42 is opened at a block 80. Opening the first switch 42 disconnects the second terminal 34 from the second socket 40 so that no power is delivered to the powered device 60. Thereafter, control returns to the decision block 72 to await reset.

After an automatic shutoff at the block 80, as discussed above, no power is supplied to the power device 60, even if the device is turned on. Instead, the power circuit 10 thereafter continues to loop around the decision block 72 until the first reset button 26 is depressed. Once the first reset button 26 is depressed, then the first switch 42 is closed to electrically connect the second terminal 34 to the second socket 40 to enable power to the first outlet 14.

As is apparent, the control circuit 44 could utilize appropriate timing delays and/or averaging and the like to avoid inadvertent shutoff, as will be apparent.

In the illustrated embodiment of the invention, a single knob 30 selects a standby power level for both outlets 14 and 16. As is apparent, a second knob and variable adjustment device could be added to independently set a standby power level for each outlet 14 and 16 separately. Similarly, a single reset button could be used which would reset either or both outlets 14 and 16.

Referring to FIG. 4, an automatic switch power circuit 110 according to an alternative embodiment is illustrated. In this embodiment, the switch power circuit 10 is implemented in a receptacle in the form of a plug 112 connected via a cable 114 to a powered device 116. The plug 112 includes a first terminal or pin 118 and a second terminal or pin 120. The pins 118 and 120 are for connecting to a conventional outlet. Although not shown, a ground pin could also be included. The cable 114 includes a first conductor 122 electrically connected to the first terminal 118. A switch 126 is connected between the second terminal 120 and a second conductor 124 of the cable 114. A control circuit 128 is connected to the terminals 118 and 120 to be powered by the same. The switch 126 is connected to and is operated by the control circuit 128. A sensor 130 senses power drawn through the plug 112, such as current through the second terminal 120. The control circuit 128 is also connected to a reset switch 132 and a user variable adjustment device 134.

As is apparent, the control circuit 128 and related input and output devices of the switched power circuit I 10 are similar to those of the switched power circuit 10 discussed above. In fact, operation of the control circuit 128 is essentially identical thereto. The switch 126 is electrically connected between two nodes, i.e., the second conductor 124 and second terminal 120 for selectively electrically connecting these nodes. This is similar to the power circuit 10 of FIG. 2 in which the first switch 42 is connected between first and second nodes in the form of the second terminal 34 and the second socket 40.

In the embodiment of FIG. 4, the plug 112 can be plugged into any outlet to provide power to the powered device 116. When the control circuit 128 determines that the powered device 116 is drawing standby power, using the flow diagram of FIG. 3, the control circuit 128 opens the switch 126 to automatically shut off power to the power device 116. Power remains shut off until the reset button 132 is depressed. The desired standby power level is set using the user select variable adjustment device 134.

In accordance with the invention, the switches 42, 56 and 126 could be of any known form for switching power. For example, the switches could be control relays or could be solid state devices, as desired. The control circuit 44 or 128 could be a processing circuit or it could be an analog or discrete control circuit.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention, there is provided an automatic switched power circuit with automatic shutoff under standby power conditions.

I claim:

1. An automatic switched power circuit with automatic shutoff under standby power conditions, comprising:
a power receptacle including first and second nodes for selectively supplying power from a power source to a powered device;
sensing means for sensing power drawn by the power receptacle;
switch means electrically connected between the first and second nodes for selectively electrically connecting the first and second nodes; and
control means, coupled to said sensing means and said switch means, for determining if power drawn by the power receptacle comprises standby power and in response thereto operating the switch means to disconnect the first and second nodes.

2. The automatic switched power circuit of claim 1 wherein the control means comprises user select means for selecting a standby power level and the control means compares sensed power to the standby power level to determine if power drawn by the power receptacle comprises standby power.

3. The automatic switched power circuit of claim 1 wherein the power receptacle comprises a plug.

4. The automatic switched power circuit of claim 1 wherein the power receptacle comprises an outlet.

5. The automatic switched power circuit of claim 1 wherein the control means comprises means for manually resetting the control means to operate the switch means to electrically connect the first and second nodes.

6. The automatic switched power circuit of claim 1 wherein the control means comprises a programmable control device operating in accordance with a stored program.

7. The automatic switched power circuit of claim 1 wherein the switch means comprises a control relay.

8. An automatic switched power circuit with automatic shutoff under standby power conditions, comprising:
a power outlet including first and second power terminals for connection to a power source and first and second sockets for receiving a plug of a powered device, the first terminal being electrically connected to the first socket;
a switch electrically connected between the second terminal and the second socket;
a sensor for sensing power drawn through the power outlet; and
a control circuit coupled to the sensor and the switch, the control circuit determining if power drawn through the power outlet comprises standby power and in response thereto operating the switch to disconnect the second terminal and the second socket.

9. The automatic switched power circuit of claim 8 wherein the control circuit comprises a user select device for selecting a standby power level and the control circuit compares sensed power to the standby power level to determine if power drawn by the power outlet comprises standby power.

10. The automatic switched power circuit of claim 8 wherein the control circuit comprises a manual reset device to selectively operate the switch to electrically connect the second terminal to the second socket.

11. The automatic switched power circuit of claim 8 wherein the control circuit comprises a programmable control device operating in accordance with a stored program.

12. The automatic switched power circuit of claim 8 wherein the switch comprises a control relay.

13. The automatic switched power circuit of claim 8 wherein the control circuit determines if power drawn through the power outlet comprises standby power by determining if some power is drawn through the power outlet and the amount of power drawn is less than a selectable standby power limit.

14. The automatic switched power circuit of claim 8 further comprising a 2 second power outlet including third and fourth sockets for receiving a plug of a powered device, the first terminal being electrically connected to the third socket; a second switch electrically connected between the second terminal and the fourth socket; a second sensor for sensing power drawn through the second power outlet; and the control circuit is coupled to the second sensor and the second switch and determines if power drawn through the second power outlet comprises standby power and in response thereto operating the second switch to disconnect the second terminal and the fourth socket.

15. An automatic switched power circuit with automatic shutoff under standby power conditions, comprising:
a power plug including first and second power terminals for connection to a power source and first and second conductors connected to a powered device, the first terminal being electrically connected to the first conductor;
a switch electrically connected between the second terminal and the second conductor;
a sensor for sensing power drawn through the power plug; and
a control circuit coupled to the sensor and the switch, the control circuit determining if power drawn through the power plug comprises standby power and in response thereto operating the switch to disconnect the second terminal and the second conductor.

16. The automatic switched power circuit of claim 15 wherein the control circuit comprises a user select device for selecting a standby power level and the control circuit compares sensed power to the standby power level to determine if power drawn by the power plug comprises standby power.

17. The automatic switched power circuit of claim 15 wherein the control circuit comprises a manual reset device to selectively operate the switch to electrically connect the second terminal to the second conductor.

18. The automatic switched power circuit of claim 8 wherein the control circuit comprises a programmable control device operating in accordance with a stored program.

19. The automatic switched power circuit of claim 8 wherein the switch comprises a control relay.

20. The automatic switched power circuit of claim 8 wherein the control circuit determines if power drawn through the power plug comprises standby power by determining if some power is drawn through the power outlet and the amount of power drawn is less than a selectable standby power limit.
